(19) United States
(12) Patent Application Publication
(10) Pub. No.: US 2011/0255976 A1
(43) Pub. Date: Oct. 20, 2011

(54) Manufacturing method for closed vane wheels

(75) Inventor: Werner Jahnen, Welsikon (CH)

(73) Assignee: Sulzer Markets and Technology AG, Winterthur (CH)

(21) Appl. No.: 13/124,186

(22) PCT Filed: Oct. 20, 2009
(86) PCT No.: PCT/EP2009/063705

§ 371 Date: Jul. 7, 2011

(30) Foreign Application Priority Data
Oct. 20, 2008 (EP) 08167041.6

(51) Int. Cl. F01D 5/22; C25F 3/02; B23H 1/00

(52) U.S. Cl. 416/177; 219/69.17; 205/646

(57) ABSTRACT

In a manufacturing method for closed vane wheels having vanes (2, 2a) between which vane channels (3) are formed which have a predefined shape, openings for the vane channels are prepared by means of a program-controlled chip forming cutting apparatus in a blank in a chip forming cutting process. In the manufacturing method, in a further workstep, electrodes (11) of an apparatus for spark erosion or for electrochemical stock removal are additionally introduced into the openings and a part of the predefined shape of the vane channel (3) is manufactured by means of spark erosion or by means of electrochemical stock removal.

The invention relates to a manufacturing method for closed vane wheels in accordance with the preamble of claim 1 and to a closed vane wheel manufactured with such a method.

Closed vane wheels are used in fluid flow engines such as in pumps or turbines to transfer energy to a fluid such as gas, vapor or liquid or, vice versa, to transfer energy from a fluid to the vane wheel. A closed vane wheel for this purpose contains one or more vanes which are arranged between a front cover plate and a rear cover plate, also called a top plate and a bottom plate, with the rear cover plate and/or the vanes normally being connected to a hub which can be made for the reception of a shaft. Vane channels are formed between the vanes which are closed as a result of the arrangement of the vanes between the front and rear cover plates.

The technical casting manufacture of closed vane wheels has a long tradition. For this purpose, casting molds with cores are used, with the latter defining the shape of the vane channels. Closed vane wheels which are manufactured in a technical casting process have the disadvantage that defective points in the interior of the vane wheel can practically not be repaired and that the quality control is critical, in particular with comparatively thin vanes or thin-walled cover plates. Furthermore, the limited precision of the closed vane wheels and the roughness of the cast surfaces also represent a problem depending on the application.

A switch has therefore been made to manufacturing closed vane wheels for demanding applications by means of chip forming cutting machining. For this purpose, the shape of the vane channels is worked out in a chip forming cutting process from a blank which is usually made of solid material. Furthermore, the outer shape of the vane wheel can also be produced in a chip forming cutting process. The chip forming cutting machining has in particular proven itself when the material of the vane wheel has good cutting properties and the geometry is comparatively simple so that all the regions in the vane wheel to be machined can be reached using a chip forming cutting tool.

Depending on the use of the vane wheels, they are put under heavy strain in operation in that they are exposed to substantial centrifugal forces at circumferential speeds of up to 400 m/s. Such vane wheels are therefore produced from solid material while using high-strength steels, stainless steels, super alloys and other suitable materials. It is disadvantageous in this process that some of these materials make special demands on the chip forming cutting machining due to their toughness and/or hardness.

Furthermore, the geometry of the vane wheel to be manufactured can also produce problems in the chip forming cutting machining. A close staggering of the vanes at the inlet of the vane wheel and/or a strong curvature of the vanes can have the result, for example, that the whole vane cannot be machined in a chip forming cutting process for reasons of geometry or that only a part of the vane channel can be produced in a chip forming cutting process and that regions remain at the vanes which are usually made in wedge shape and which project into the vane channel. In a similar manner, a comparatively strong curvature of the front cover plate can have the result that not the whole cover surface of the vane channel can be machined in a chip forming cutting process for reasons of geometry and that regions remain at the cover surface which are usually made in wedge shape and which project into the vane channel.

In chip forming cutting processing, however, difficulties can also arise when the region to be machined can admittedly be reached by a chip forming cutting tool from a geometrical aspect, but the machining conditions are unfavorable in that the region to be machined is, for example, disposed far inside the vane channel and long tools are required which can only take up and exert small transverse forces. The advance speed in this case has to be reduced, whereby the machining times and the costs are increased accordingly. The unfavorable machining conditions also include the fact that for reasons of geometry it is also necessary to deviate from the ideal angle of engagement of the chip forming cutting tool, which can result in unacceptable machining results. These difficulties are further amplified if the material to be machined makes particular demands on the chip forming cutting machining. For the aforesaid reasons, the chip forming cutting machining can be uneconomical even if a chip forming cutting machining would generally be possible from geometrical aspects.

A known solution to the machining problems which occur with closed vane wheels manufactured in a chip forming cutting process consists of manufacturing the vane wheel from a plurality of prefabricated parts which are connected to one another by means of welding. For example, first the hub, the rear cover plate and the vanes can be milled from one solid piece and subsequently the separately manufactured front cover plate can be welded onto the vanes. It is furthermore possible, for example, to mill the hub, the rear cover plate and the outer part of the front cover plate as well as the vanes from one solid piece and subsequently to weld the separately manufactured inner part of the front cover plate onto the vanes. The welded seams and the distortion which arises by the welding are disadvantageous with such welded vane wheels as is the considerable effort for the fixing and, where applicable, for the inert gas, which is required in materials which can only be welded in an inert gas atmosphere. The effort for the quality assurance of welded vane wheels is usually likewise comparatively high and a certification of the process is difficult. Furthermore, the achievable strength is limited and can only be increased with additional effort.

It is furthermore known to manufacture vane wheels by means of spark erosion. For this purpose, the vane channels are completely eroded by means of shaped electrodes from a blank usually made of solid material. This process is, however comparatively slow and complex and/or expensive. The manufacture of a vane wheel by means of spark erosion can thus take up a plurality of weeks. Furthermore, the available spark erosion machines are equipped as standard only with a three-axis control, whereby the control of the spark erosion machining is made complicated. If higher demands are made on the precision, the effort increases since the shaped electrodes in this case have to be replaced comparatively frequently. Due to the large effort, the manufacture of vane wheels by means of spark erosion is only used in individual cases and with materials where other manufacturing processes fail.

It is the object of the present invention to provide a manufacturing method by means of which closed vane wheels can be made from one piece and which enables the manufacture of comparatively complicated geometries whose manufacture with machining processes from the prior art is not possible or is comparatively less economical. It is a further object of the present invention to provide a closed vane wheel which is manufactured using such a manufacturing method.

This object is satisfied in accordance with the invention by the manufacturing method for closed vane wheels defined in claim 1 and by the closed vane wheel defined in claim 15.

In the manufacturing method in accordance with the invention for closed vane wheels with vanes between which vane channels are formed which have a predefined shape, openings for the vane channels are prepared by means of a program-controlled chip forming cutting apparatus in a blank in a chip forming cutting process. In the manufacturing method, electrodes of an apparatus for spark erosion or for electrochemical stock removal are additionally introduced into the openings in a further workstep and a part of the predefined shape of the vane channel is manufactured by means of spark erosion or by means of electrochemical stock removal. The openings for the vane channels prepared in a chip forming cutting process can, for example, be a rough form of the vane channels and/or the openings prepared in a chip forming cutting process for the vane channels can be throughgoing.

In an advantageous embodiment variant, a part of the predefined shape of the vane channels is produced in a chip forming cutting process in addition to the openings. Advantageously, additionally to the openings, the larger part, in particular at least 75% or at least 90°, of the predefined shape of the vane channel is produced in a chip forming cutting process. The chip forming cutting production of a part or of the larger part of the predefined shape of the vane channels can take place, for example, before the spark erosion so that the part of the predefined shape to be eroded can be kept small or reduced to a minimum.

In a further advantageous embodiment variant, the vane wheel includes a front cover plate and a rear cover plate, with the vane channels and/or the vanes and/or one or both cover plates being able to have a curvature.

In an advantageous embodiment of the manufacturing method, a chip forming cutting process is used in which respective curved guide surfaces for the chip forming cutting machining by means of a chip forming cutting tool are provided in the openings to be prepared for the vane channels and/or in the vane channels to be prepared, said curved guide surfaces being adapted to the shape and spatial position of the vane channels such that the chip forming cutting tool is not brought into contact with a marginal surface bounding the vane channels on chip forming cutting and such that the chip forming cutting tool is respectively guided along a guide surface in the chip forming cutting method and a machining region given by the respective guide surface is machined in a chip forming cutting process to prepare an opening and/or parts of a vane channel, with the chip forming cutting tool having a guide axis and being guided along the respective guide surface at a constant guide angle with respect to the guide axis.

Advantageously, the guide surfaces inside a vane channel are not arranged as a parallel surface and/or an offset surface to any marginal surface and/or any end surface. Furthermore, if necessary, a tool coordinate and/or a tool vector of the chip forming cutting tool can be adapted to the guide surface. Advantageously, in each case at least two guide surfaces of an opening and/or of a vane passage are not parallel.

In an advantageous embodiment variant, the guide angle is not changed during the manufacture of an opening and/or of a part of a vane channel. In a further advantageous embodiment variant, the guide angle is varied during the manufacture of an opening and/or of a part of a vane channel on a change from one guide surface to the next guide surface in accordance with a preset scheme.

Depending on the application, the change of the chip forming cutting tool from one guide surface to a next guide surface is carried out discontinuously and/or a bore is provided in the region of the two guide surfaces or in the region of all the guide surfaces of an opening and/or of a part of a vane channel for the changing from one guide surface to a next guide surface. The change of the chip forming cutting tool from one guide surface to a next guide surface can, however, also be carried out continuously, for example spirally in the form of a helix.

Independently of the embodiment variants described above, the guide angle is usually set to a value between 70° and 120° or between 85° and 95° or between 88° and 92° and advantageously to a value of essentially 90°.

Furthermore, the invention includes a closed vane wheel manufactured by means of a manufacturing method in accordance with one of the embodiments and embodiment variants described above.

The manufacturing method in accordance with the invention has the advantage that closed vane wheels can be manufactured from one piece with it whose vane channels cannot be produced in a purely chip forming cutting process due to the geometry and/or whose production would be uneconomical with a purely chip forming cutting machining of the vane channels. Thanks to the fact that a part of the vane passage shape, and usually the larger part of the vane passage shape, can be produced in a chip forming cutting process and only a usually smaller part is manufactured by means of spark erosion, a cost optimization is possible.

The above description of embodiments and embodiment variants only serves as an example. Further advantageous embodiments can be seen from the dependent claims and from the drawing. Furthermore, individual features from the embodiments and variants described or shown can also be combined with one another within the framework of the present invention to form new embodiments.

The invention will be explained in more detail in the following with reference to the embodiments and to the drawing. There are shown:

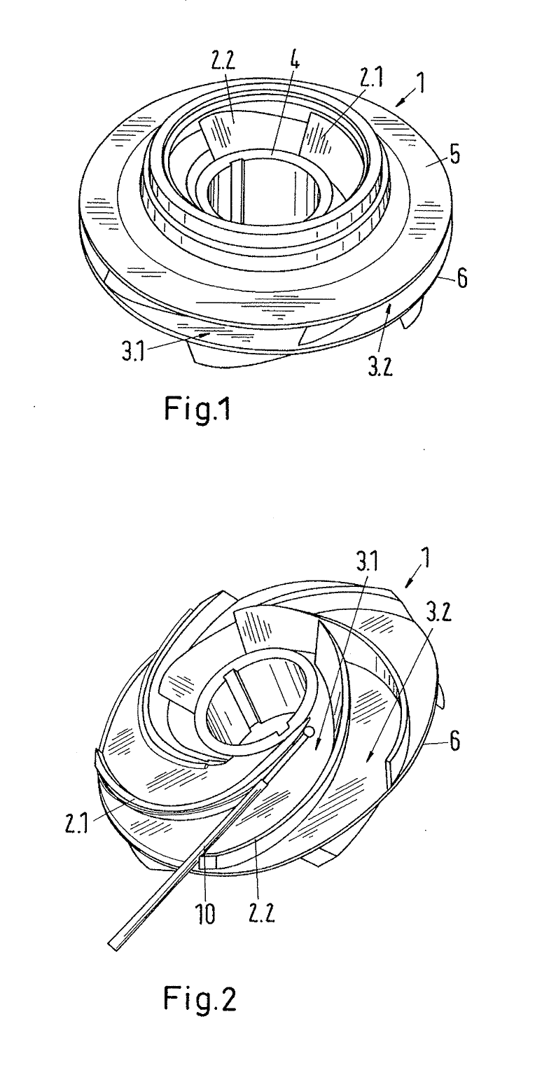

FIG. 1 a closed vane wheel in whose production difficulties can arise with purely chip forming cutting machining of the vane channels;

FIG. 2 the vane wheel in accordance with FIG. 1 with a chip forming cutting tool introduced into a vane channel, with the front cover plate being omitted to make the vanes visible;

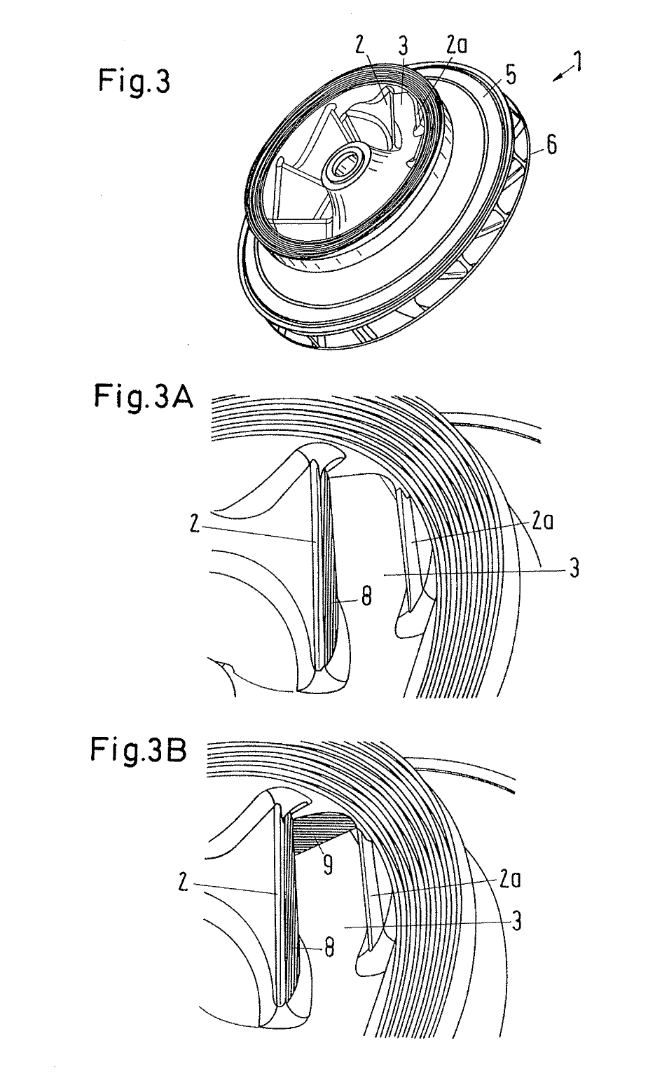

FIG. 3 an embodiment of a closed vane wheel in accordance with the present invention;

FIG. 3A a detailed view of an embodiment variant for the vane wheel in accordance with FIG. 3 with a vane at which a wedge-shaped region has remained on one side after the chip forming cutting machining;

FIG. 3B a detailed view of an embodiment variant of the vane wheel in accordance with FIGS. 3 and 3A having a vane channel at whose front cover surface a wedge-shaped region has additionally remained after the chip forming cutting machining;

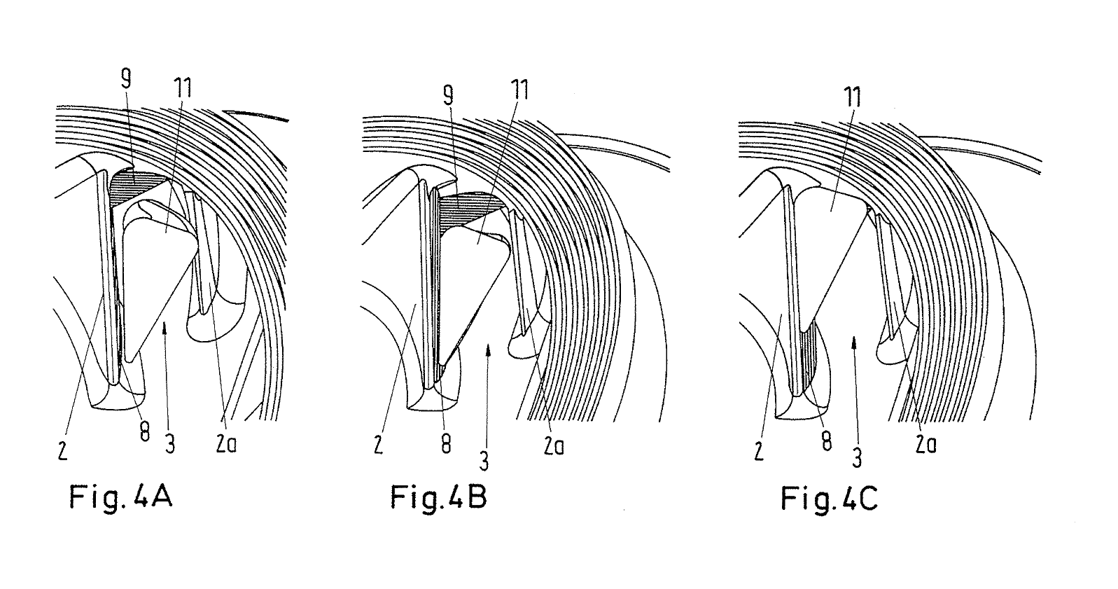

FIGS. 4A-4C the wedge-shaped regions of the embodiment in accordance with FIG. 3B on the machining by means of a spark erosion method in accordance with an embodiment of the manufacturing method in accordance with the invention;

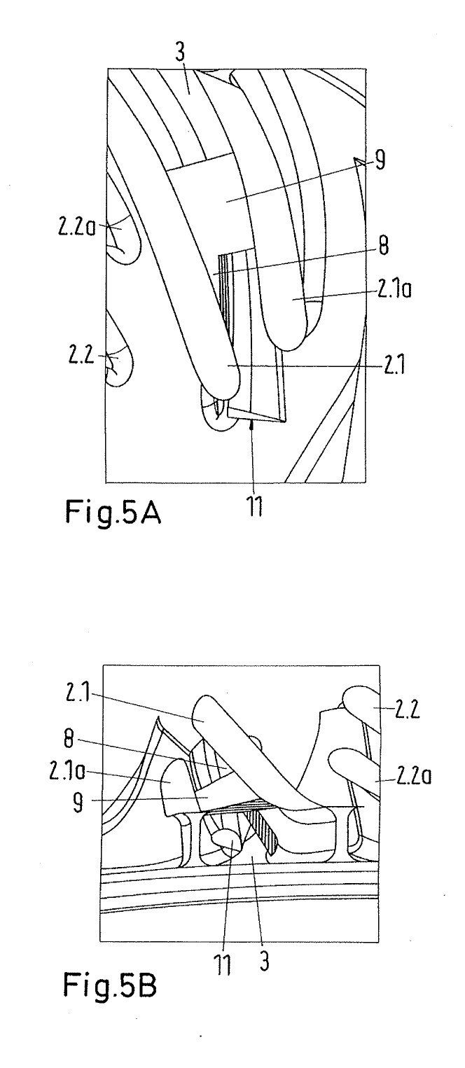

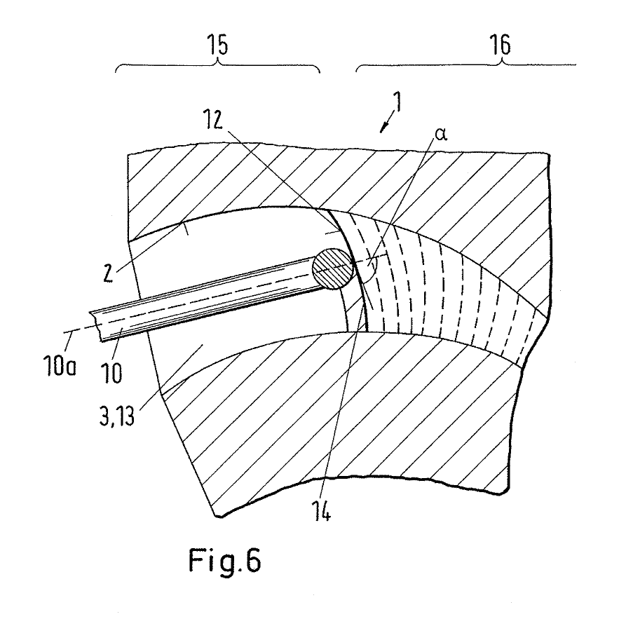

FIG. 5A the embodiment in accordance with FIG. 3B viewed from the front side of the vane wheel, with the front cover plate being omitted in the drawing to make the vanes visible;

FIG. 5B the embodiment in accordance with FIG. 3B viewed obliquely from the outside, with the front cover plate being omitted in the drawing to make the vanes visible; and

FIG. 6 a section of a vane wheel on the machining by means of a chip forming cutting method in accordance with a further embodiment of the manufacturing method in accordance with the invention.

FIG. 1 shows a closed vane wheel in whose production in one piece difficulties can arise with purely chip forming cutting machining of the vane channels. The vane wheel 1 can contain one or more vanes 2.1, 2.2 which are arranged between a front cover plate 5 and a rear cover plate 6, with the rear cover plate and/or the vanes normally being connected to a hub 4 which can be made for the reception of a shaft. One or more vane channels 3.1, 3.2 are formed between the vanes 2.1, 2.2; they have a pre-set shape and are closed as a consequence of the arrangement of the vanes between the front and rear cover plates.

FIG. 2 shows the vane wheel in accordance with FIG. 1 described above with a chip forming cutting tool 10 which is introduced into a vane channel 3.1, with the front cover plate being omitted in the drawing to make the vanes visible in their full length. The vane wheels shown in FIGS. 1 and 2 have the same structure irrespective of the different representation. Due to the length of the vanes, a comparatively long chip forming cutting tool is required for the chip forming cutting machining of the vane channels 3.2, 3.2 of the vane wheel shown, for example, as shown in FIG. 2, a chip forming cutting tool with a long shaft. The curvature and staggering of the vanes 2.1, 2.2 of the vane wheel shown is such that a purely chip forming cutting production of the vane channels appears just still possible. Due to the length and the converging shaft of the chip forming cutting tool, however, a low advance speed and thus increased machining costs are to be anticipated. Problems in the chip forming cutting machining also result when a comparatively small rounding radius is required at the transition between the vanes and the cover plates.

FIG. 3 shows an embodiment of a closed vane wheel which was produced using a manufacturing method in accordance with the present invention. The vane wheel 1 can contain one or more vanes 2, 2a which are arranged between a front cover plate 5 and a rear cover plate 6. One or more vane channels 3 are formed between the vanes 2, 2a. The vane channels have a predefined shape and are closed as a consequence of the arrangement of the vanes between the front and rear cover plates. The individual vanes can have different lengths, for example in that, as shown in FIG. 3, shortened vanes 2a, also called “splitter vanes”, are arranged between vanes 2 of full length.

In a further advantageous embodiment variant, the vane wheel includes a front cover plate and a rear cover plate, with the vane channels 3 and/or the vanes 2, 2a and/or one or both cover plates 5, 6 being able to have a curvature.

In the method in accordance with the invention openings for the vane channels 3 are prepared by means of a program-controlled chip forming cutting apparatus in a blank in a chip forming cutting process in that the openings are milled out, for example, in a known manner using a multi-axis CNC milling machine. The openings for the vane channels prepared in a chip forming cutting process can, for example, be a rough form of the vane channels and/or the openings prepared in a chip forming cutting process for the vane channels can be throughgoing. In an advantageous embodiment variant, in addition to the openings, a part or the larger part of the predefined shape of the vane channels, for example at least 75% or at least 90%, is produced in a chip forming cutting process.

FIG. 3A shows a detailed view of an embodiment variant for the vane wheel in accordance with FIG. 3 with a vane 2 at which a wedge-shaped region 8, which projects into the vane channel 3, has remained on one side after the chip forming cutting machining. Such wedge-shaped regions can arise, for example, when a purely chip forming cutting production of the vane channels 3 is not possible or is not economical due to the curvature and/or to the staggering of the vanes 2, 2a. FIG. 3B shows a detailed view of an embodiment variant for the vane wheel in accordance with FIG. 3 with a vane channel 3 at whose cover surface a wedge-shaped region 9, which projects into the vane channel 3, has additionally remained after the chip forming cutting machining. Such wedge-shaped regions 9 can arise, for example, when a purely chip forming cutting production of the vane channels 3 is not possible or is not economical due to the curvature of the front cover plate.

In the manufacturing method in accordance with the present invention, electrodes of an apparatus for spark erosion or for electrochemical stock removal are additionally introduced in a further workstep into the openings or vane channels and a part of the predefined shape of the vane channels is manufactured by means of spark erosion or by means of electrochemical stock removal. FIGS. 4A-4C show the wedge-shaped regions 8, 9 of the embodiment in accordance with FIG. 3B in the machining by means of a spark erosion electrode 11 in accordance with an embodiment of the manufacturing method in accordance with the invention. In FIG. 4A, the spark erosion electrode 11 is introduced into the vane channel 3. FIG. 4B shows the spark erosion electrode 11 in the machining of the wedge-shaped region 8 which is formed at the vane 2; and in FIG. 4C, the spark erosion electrode 11 is applied to the vane 2 and to the front cover surface of the vane channel 3, with parts of the wedge-shaped regions 8, 9 already being eroded away.

FIG. 5A shows the embodiment in accordance with FIG. 3B viewed from the front side of the vane wheel, with the front cover plate having been omitted in the drawing to make the vanes visible. The vane wheel shown contains a plurality of vanes 2.1, 2.2, 2.1a, 2.2a which are arranged between a front cover plate and a rear cover plate. Vane channels 3 are formed between the vanes; they have a pre-set shape and are closed as a consequence of the arrangement of the vanes between the front and rear cover plates. The individual vanes can have different lengths, for example in that, as shown in FIG. 5A, shortened vanes 2.1a, 2.2a, also called “splitter vanes”, are arranged between vanes of full length. After the chip forming cutting machining, a respective wedge-shaped region 8, 9 has remained at the vane 2.1 and at the front cover surface of the vane channel 3, with both regions projecting into the vane channel 3. FIG. 5A additionally shows a spark erosion electrode 11 which is introduced into the vane channel 3 for the machining of the wedge-shaped regions 8, 9.

FIG. 5B shows the same embodiment as FIG. 5A viewed obliquely from the outside, with the front cover plate being omitted in the drawing to make the vanes visible. Reference is made to the aforesaid description of FIG. 5A with respect to details of FIG. 5B.

The spark erosion electrode used in the manufacturing method in accordance with the invention is advantageously made as a shaped electrode which is matched to the shape of the vane channel. Normally, a plurality of shaped electrodes are required, for example three or four, since usually different regions of the vane channels have to be machined. Furthermore, the shaped electrodes are worn and have to be replaced in dependence on the desired precision of the machining. The shape of the vane channels is advantageously produced in a chip forming cutting process where this is possible and/or economic and the shape of the vane channels is subsequently established in the not finished regions by means of spark erosion or by means of electrochemical stock removal. A program-controlled spark erosion machine or a machine for electrochemical stock removal having four or more controlled axes in each case is advantageously used for the spark erosion or electrochemical stock removal.

A vane channel of a vane wheel in accordance with the invention has a length of typically 30 mm to 300 mm and a width and/or height of typically 10 mm to 200 mm. In individual cases, the named dimensions can, however, deviate considerably from the values set forth.

A metal or a metal alloy is advantageously used as the material for the closed vane wheel in the manufacturing method in accordance with the invention, for example aluminum, titanium, steel, nickel, an alloy of aluminum or magnesium, a base alloy of nickel or cobalt, wrought or cast material, a non-ferrous metal, but also any other material which can be machined in a chip forming cutting process and which can additionally be selectively eroded or electrochemically removed.

In an advantageous embodiment of the manufacturing method in accordance with the invention, a chip forming cutting process is used which will be explained in the following with reference to FIG. 6 and in which respective curved guide surfaces 14 for the chip forming cutting machining by means of a chip forming cutting tool 10 are provided in the openings 13 to be prepared for the vane channels 3 and/or in the vane channels 3 to be prepared, said curved guide surfaces being adapted to the shape and spatial position of the vane channels such that the chip forming cutting tool 10 is not brought into contact with a marginal surface 2 bounding the vane channels on the chip forming cutting and such that the chip forming cutting tool 10 is respectively guided along a guide surface 14 in the chip forming cutting method and a machining region 12 given by the respective guide surface is machined in a chip forming cutting process to prepare an opening 13 and/or parts of a vane channel 3, with the chip forming cutting tool 10 having a guide axis and being guided along the respective guide surface 14 at a constant guide angle α with respect to the guide axis. The named guide angle is also frequently called an engagement angle.

FIG. 6 shows a detail of a closed vane wheel 1 in section. The vane wheel contains an opening 13 to be prepared, which is advantageously made as a vane channel 3, and curved guide surfaces 14. A chip forming cutting tool 10 having a guide axis 10a is guided by a manipulator of a chip forming cutting apparatus not shown in FIG. 6, for example a multiaxial CNC milling machine such as a five-axis CNC milling machine, in a chip forming cutting process along a guide surface 14. In FIG. 6, a part of the opening 13 to be prepared or of the vane channel 3 to be prepared is already completed in a starting region 15, whereas the opening or the vane channel is not yet completed in a region 16 adjacent thereto. Expediently, all the guide surfaces 14 are calculated before the start of the chip forming cutting machining for the manufacture of the opening 13 or of the vane channel 3. In FIG. 6, the guide surfaces in the machining region 12 are shown schematically as curved, dashed lines. In accordance with the invention, the chip forming cutting tool 10 is guided at a constant angle a to the respective guide surface with respect to its guide axis 10a. The guide surfaces 14 are in this respect advantageously defined so that the tool can cut out the total opening 13 or the total vane channel 3 without the guide tool coming into contact with one of the marginal regions 2 which bound the opening or the vane channel.

The guide surfaces 14 are advantageously calculated so that the chip forming cutting tool 10 is guided on the chip forming cutting at one and the same angle α namely substantially at the ideal guide angle given by the manufacturer for the chip forming cutting tool at least with respect to specific guide surfaces and optionally with respect to all guide surfaces calculated. Specific differences of, for example, +/−5° or +/−1° or less from the ideal guide angle are generally tolerable if the quality of the vane wheel manufactured in a chip forming cutting process does not suffer and if the chip forming cutting tool still works substantially ideally.

Advantageously, in the chip forming cutting method described above, the guide surfaces 14 within an opening 13 to be manufactured or within a vane channel 3 are not arranged as a parallel surface and/or offset surface to any marginal surface 2 and/or any end surface. Within the framework of this application, offset surfaces are to be understood as surfaces which are admittedly not parallel in the strict sense but do have the same spacing from one another everywhere. An example for this are e.g. two concentric, spherical shells of different diameters which have a fixed spacing from one another over the total surface, but which nevertheless have different radii of curvature.

Furthermore, if necessary, a tool coordinate and/or a tool vector of the chip forming cutting tool 10 can be adapted to the guide surface 14. Advantageously, in each case at least two guide surfaces of an opening and/or of a vane passage are not parallel and do not form any offset surfaces to one another.

In an advantageous embodiment variant, the guide angle α is not changed during the manufacture of an opening and/or of a part of a vane channel 3. In a further advantageous embodiment variant, the guide angle α is varied in accordance with a preset scheme during the manufacturing of an opening 13 and/or of a part of a vane channel 3 on a change from one guide surface to the next, with the guide angle advantageously only differing a little, for example +/−5° or +/−1°, from the ideal guide angle for all guide surfaces. Depending on the demands of the material to be machined or on the geometry to be manufactured or in dependence on other parameters, the change of the chip forming cutting tool from one guide surface to the next can take place discontinuously and/or a bore can be provided in the region of the two guide surfaces or in the region of all guide surfaces of an opening and/or of a part of a vane channel for the change from one guide surface to a next guide surface. The change of the chip forming cutting tool from one guide surface to a next guide surface can, however, also be carried out continuously, for example spirally in the form of a ramp or of a helix. This means, for example, that the chip forming cutting tool is advanced more or less continuously in an advancing direction of the chip forming cutting tool, for example, substantially perpendicular to a guide surface 14, such that the transition from a guide surface does not take place discontinuously, but gradually, so that the chip forming cutting tool carries out e.g. a spiral or helical movement in the advancing direction.

Independently of the embodiments and embodiment variants described above, the guide angle α is normally ideally set to the chip forming cutting tool, for example to a value between 70° and 120° or between 85° and 95° or between 88° and 92° and advantageously to a value of substantially 90°.

The chip forming cutting process described above permits a workpiece to be machined completely with a more or less constant ideal guide angle even if it has a very complex geometrical structure and the material is difficult to cut because e.g. it has a large hardness and/or a high strength and/or other properties which make the chip forming cutting more difficult.

It is in particular also possible with the chip forming cutting process described above to provide undercuts in the production of the vane channels in that the guide surfaces 14 on or along which the chip forming cutting tool 10 is guided at a constant guide angle α is selected, that is calculated, suitably, with specifically a conical chip forming cutting tool also being able to be used with which even undercuts can be realized while maintaining a constant guide angle to the guide surface.

Furthermore, the invention includes a closed vane wheel manufactured by means of a manufacturing method in accordance with one of the embodiments and embodiment variants described above. Such closed vane wheels have the advantage that they are made of one piece and that comparatively short throughput times for prototypes and a comparatively high precision of the geometrical shape can be achieved in comparison with cast vane wheels.

1. A manufacturing method for closed vane wheels having vanes (2, 2.1, 2.2, 2a, 2.1a, 2.2a), between which vane channels (3, 3.1, 3.2) are formed which have a predefined shape, with openings for the vane channels being prepared in a blank in a chip forming cutting process by means of a program-controlled chip forming cutting apparatus, characterized in that electrodes (11) of an apparatus for spark erosion or for electrochemical stock removal are introduced into the openings in a further workstep and a part of the predefined shape of the vane channels (3, 3.1, 3.2) is manufactured by means of spark erosion or by means of electrochemical stock removal.

2. A manufacturing method in accordance with claim 1, wherein the openings prepared in a chip forming cutting process for the vane channels are a rough form of the vane channels; and/or wherein the openings prepared in a chip forming cutting process for the vane channels are throughgoing.

3. A manufacturing method in accordance with claim 1, wherein, in addition to the openings, a part of the predefined shape of the vane channels (3, 3.1, 3.2) is produced in a chip forming cutting process.

4. A manufacturing method in accordance with claim 3, wherein, in addition to the openings, the larger part, in, particular at least 75% or at least 90%, of the predefined shape of the vane channels (3, 3.1, 3.2) is produced in a chip forming cutting process.

5. A manufacturing method in accordance with claim 1, wherein the vane wheel includes a front cover plate (5) and a rear cover plate (6); and wherein in particular the vane channels (3, 3.1, 3.2) and/or the vanes (2, 2.1, 2.2, 2a, 2.1a, 2.2a) and/or one or both cover plates (5, 6) have a curvature.

6. A manufacturing method in accordance with claim 1, wherein a chip forming cutting process is used in which respective curved guide surfaces (14) for the chip forming cutting machining by means of a chip forming cutting tool (10) are provided in the openings to be prepared for the vane channels and/or in the vane channels (3, 3.1, 3.2) to be prepared, said curved guide surfaces being adapted to the shape and spatial position of the vane channels such that the chip forming cutting tool is not brought into contact with a marginal surface bounding the vane channels on chip forming cutting and such that the chip forming cutting tool (10) is respectively guided along a guide surface (14) in the chip forming cutting method and a machining region (12) given by the respective guide surface is machined in a chip forming cutting process to prepare an opening and/or parts of a vane channel, characterized in that the chip forming cutting tool (10) has a guide axis (10a) and is guided along the respective guide surface at a constant guide angle (α) with respect to the guide axis.

7. A manufacturing method in accordance with claim 6, wherein the guide surfaces (14) within a vane channel (3, 3.1, 3.2) are not arranged as a parallel surface and/or offset surface to any marginal surface and/or end surface.

8. A manufacturing method in accordance with claim 6, wherein a tool coordinate and/or a tool vector of the chip forming cutting tool (10) are/is adapted to the guide surface (14).

9. A manufacturing method in accordance with claim 6, wherein in each case at least two guide surfaces (14) of an opening and/or of a vane channel are not parallel and do not form any offset surfaces to one another.

10. A manufacturing method in accordance with claim 6, wherein the guide angle (α) is not changed during the manufacturing of an opening and/or of a part of a vane channel.

11. A manufacturing method in accordance with claim 6, wherein the guide angle (α) is varied in accordance with a preset scheme during the manufacture of an opening and/or of a part of a vane channel on a change from one guide surface to the next guide surface.

12. A manufacturing method in accordance with claim 6, wherein the change of the chip forming cutting tool (10) from one guide surface to a next guide surface is carried out discontinuously; and/or wherein a bore is provided in the region of the two guide surfaces, in particular in the region of all the guide surfaces of an opening and/or of a part of a vane channel for the changing from one guide surface to a next guide surface.

13. A manufacturing method in accordance with claim 6, wherein the change of the chip forming cutting tool (10) from one guide surface to a next guide surface is carried out continuously, in particular spirally in the form of a helix.

14. A manufacturing method in accordance with claim 6, wherein the guide angle (α) is set to a value between 70° and 120°, in particular to a value between 85° and 95° or between 88° and 92° and preferably to a value of substantially 90°.

15. A closed vane wheel manufactured by means of a manufacturing method in accordance with claim 1.
